(19) United States
(12) Patent Application Publication
(10) Pub. No.: US 2004/0061987 A1
(43) Pub. Date: Apr. 1, 2004

(54) Self-stabilized giant magnetoresistive spin valve read sensor

(75) Inventors: Daniele Mauri, San Jose, CA (US); Tsann Lin, Saratoga, CA (US)

Correspondence Address: Ron Feece, INTERNATIONAL BUSINESS MACHINES CORPORATION, Dept. L2PA, 5600 Cottle Road, San Jose, CA, 95193, US

(73) Assignee: INTERNATIONAL BUSINESS MACHINES CORPORATION

(21) Appl. No.: 10/256,778

(22) Filed: Sep. 27, 2002

(51) Int. Cl. G11B 5/39

(52) U.S. Cl. 360/324.12

(57) ABSTRACT

A self-stabilized spin valve (SV) sensor in which a layer of high-resistance hard magnetic (HM) material is deposited under or over a SV stack to longitudinally bias the free layer by magnetostatic coupling therewith.

### BACKGROUND OF THE INVENTION

1. Field of the Invention

This invention relates generally to giant magnetoresistive (GMR) spin valve (SV) sensors for magnetic data storage devices and more particularly to a SV sensor that is self-stabilized through an indirect magnetic coupling of the ferromagnetic (FM) free layer to a hard magnetic (HM) layer.

2. Description of the Related Art

Computers often include auxiliary memory storage devices having media on which data can be written and from which data can be read for later use. A direct access storage device (DASD) or disk drive incorporating rotating magnetic disks is commonly used for storing data in magnetic form in concentric, radially-spaced tracks on the disk surfaces. Magnetic heads including read sensors are then used to read data from the tracks on the disk surfaces.

In high capacity disk drives, magnetoresistive (MR) read sensors (MR heads) are preferred in the art because of their capability to read data at greater track and linear densities than earlier thin film inductive heads. An MR sensor detects the magnetic data on a disk surface through a change in the MR sensing layer resistance responsive to changes in the magnetic flux sensed by the MR layer.

The early MR sensors rely on the anisotropic MR (AMR) effect in which an MR element resistance varies as the square of the cosine of the angle between the magnetic moment of the MR element and the direction of sense current flowing through the MR element. Recorded data can be read from a magnetic medium because the external magnetic field from the recorded magnetic medium (the signal field) changes the moment direction in the MR element, thereby changing the MR element resistance and the sense current or voltage.

The later giant magnetoresistance (GMR) sensor relies on the spin-scattering effect. In GMR sensors, the resistance of the GMR stack varies as a function of the spin-dependent transmission of the conduction electrons between two magnetic layers separated by a non-magnetic spacer layer and the accompanying spin-dependent scattering that occurs at the interface of the magnetic and non-magnetic layers and within the magnetic layers. GMR sensors using only two layers of ferromagnetic (FM) material separated by a layer of non-magnetic conductive material (e.g., copper) are generally referred to as spin valve (SV) sensors.

The SV sensor includes a nonmagnetic electrically conductive spacer layer sandwiched between a FM pinned layer structure and a FM free layer structure. An antiferromagnetic (AFM) pinning layer interfaces the pinned layer structure for pinning a magnetic moment of the pinned layer structure 90° to an air bearing surface (ABS), which is an exposed surface of the sensor that faces the magnetic disk. Two sense current leads are connected to the SV sensor for conducting a sense current therethrough. The magnetic moment of the free layer structure is free to rotate upwardly and downwardly with respect to the ABS from a quiescent position or bias point in response to positive and negative magnetic field signals present on the surface of an adjacent rotating magnetic disk. The quiescent position, which is preferably parallel to the ABS, is the position of the magnetic moment of the free layer structure with the operating-bias sense current conducted through the sensor in the absence of external magnetic fields.

The spacer layer thickness is chosen to minimize the shunting of the sense current and the magnetic coupling between the free and pinned layer structures. This thickness is typically less than the mean free path of electrons conducted through the sensor. With this arrangement, a portion of the conduction electrons are scattered at the spacer layer interfaces with the pinned and free layer structures. Such scattering is minimal when the pinned and free layer magnetic moments are parallel with one another, and increases substantially when the magnetic moments are antiparallel. Because changes in scattering affects the SV sensor resistance, the sensor resistance varies as a weighted function of cos θ, where θ is the relative angle between the magnetic moments of the pinned and free layer structures. SV sensor sensitivity is quantified in terms of the MR coefficient, δr/R, where R is the sensor resistance when the magnetic moments are parallel and δr is the change in the sensor resistance arising from shifting the moments into an antiparallel position.

Generally, two types of free layer magnetic biasing (transverse and longitudinal) are required for acceptable SV sensor performance. A transverse bias field is applied to the free layer in a direction perpendicular to the sense current flow to achieve an operating point in a linear region where the detected signal (δr/R) is roughly proportional to the variation in external magnetic field magnitude. This may be accomplished by some combination of the bias current itself, external bias currents, and the effects of other magnetic layers including the pinned layer itself. A longitudinal bias field is applied to the free layer in a direction parallel to the sense current flow to suppress Barkhausen noise by stabilizing the magnetic domain(s), which can generate noise when domain boundaries shift responsive to changes in external magnetic fields.

The art is replete with various biasing techniques for MR films. For example, in U.S. Pat. No. 3,840,898, Bajorek et al. proposed biasing an MR layer to a desired operating point by using the magnetostatic effects from a HM film separated by a thin insulating film to move the MR layer operating point to a desired B×H locus. According to this method, an operating-point bias may be applied in any direction by selecting the magnetizing direction relative to the longitudinal and transverse directions. Moreover, Bajorek et al. suggest alternatively that exchange biasing may be achieved by eliminating or breaching the separating layer between MR and HM layers. But Bajorek et al. do not consider Barkhausen noise stabilization and neither consider or suggest any practical method for applying such B×H biasing techniques to a modern GMR SV sensor.

More recently, practitioners have preferred a relatively weak longitudinal bias at the central active MR layer region compared with the bias level applied at the end portions, to improve MR layer sensitivity in the central (active) region. For example, in U.S. Pat. No. 5,329,413, Kondoh et al. describe an MR sensor with a magnetic stabilizing layer stacked on the MR sensing layer so that the two layers are exchange-coupled at the end regions and otherwise less coupled in the central (active) region. The alternative contiguous-junction (CJ) techniques involve placing a tapered HM layer at each end of the MR sense layer to similar effect. While such techniques are useful for improving sensor sensitivity while also reducing Barkhausen noise, both the exchange-coupling and hard-bias CJ methods impose demanding fabrication requirements that reduce yield and uniformity. For instance, the tapered lift-off profile of the contiguous HM layer next to the junction results in a dilution of the magnetic charge and a coercivity gradient. Both reduce the HM effects in the immediate vicinity (within one-half read-width) of the junction so that the desired balance of Barkhausen noise suppression and improved sensor sensitivity is subject to uncontrolled variability.

For instance, FIG. 1 shows a spin valve (SV) sensor 20 from the prior art that is stabilized using the hard magnetic (HM) layers 22 formed by a lift-off process. SV sensor 20 is usually fabricated using thin-film deposition techniques known in the art. For instance, a first shield (SI) layer 24 of a conductive material is formed on a substrate (not shown) and an insulating layer 26 of silicon-dioxide, or the like, is deposited over SI layer 24. The SV layers are then deposited in sequence over insulating layer 26. For example, the antiferromagnetic (AFM) pinning layer 28 is deposited followed by the ferromagnetic (FM) pinned layer 30 to form a pinned layer structure. Next, the conductive spacer layer 32 of copper, or the like, is deposited followed by the FM free layer 34. Finally, a photoresist layer (not shown) is formed over the entire assembly and is processed in the usual manner to permit all material outside of the central region 36 to be removed by etching down to insulating layer 26. After etching, a HM material is deposited over the exposed portions of insulating layer 26 and also over the remaining photoresist layer (not shown) in central region 36 and, before removing the photoresist layer covering central region 36, a conductive lead layer 38 is deposited over everything. The photoresist layer is then finally dissolved away, which “lifts off” the unwanted portions (not shown) of the HM layer 22 and lead layer 26 within central region 36, in a well-known manner. Because of this lift-off deposition procedure, the later layers are tapered to very slight thickness at the junction with central region 36. Unfortunately, the tapered lift-off profile of HM layer 22 adjacent central region 36 dilutes the magnetic charge and give rise to a coercivity gradient. This reduces the biasing effects of HM layer 22 in the immediate vicinity (within one-half read-width) of central region 36 so that the desired balance of Barkhausen noise suppression and improved sensor sensitivity cannot be precisely controlled from device to device and wafer to wafer during fabrication.

Considering another example, FIG. 2 shows a SV sensor 40 from the prior art that is stabilized using the exchange bias structure consisting of the exchange-coupled AFM layers 42 and FM layers 44, buffered by the intermediate layer 46 of cobalt, tantalum or the like. SV sensor 40 is fabricated using lift-off techniques similar to those discussed above in connection with FIG. 1. For example, the first shield (SI) layer 48 is formed, followed by the insulating layer 50 and the SV stack layers consisting of the AFM pinning layer 52, the FM pinned layer 54, the conductive spacer layer 56, the FM free layer 58 and the photoresist layer (not shown). The photoresist layer is processed in the usual manner to permit all material outside of the central region 60 to be removed by etching down to insulating layer 50. Intermediate layer 46 is then formed over the entire assembly, followed by FM layer 44, AFM layer 42 and the conductive lead layer 62. Finally, the remaining photoresist layer (not shown) is dissolved and removed together with all unwanted portions of buffer layer 46, FM layer 44, AFM layer 42 and lead layer 62 within central region 60. The tapered lift-off profiles of the external biasing layers is disadvantageous for the same reasons mentioned above: the desired balance of Barkhausen noise suppression and improved sensor sensitivity cannot be precisely controlled from device to device and wafer to wafer during fabrication.

There is accordingly a clearly-felt need in the art for a more efficient SV stabilization geometry that is simple enough to improve sensor uniformity during manufacture. The relevant unresolved problems and deficiencies are clearly felt in the art and are solved by this invention in the manner described below.

### SUMMARY OF THE INVENTION

This invention solves the problem of balancing Barkhausen noise suppression and improved sensor sensitivity without losing control of manufacturing variability by introducing a simplified free-layer longitudinal biasing geometry that can be defined in a single milling step during manufacture. According to this invention, a self-stabilized spin valve (SV) sensor may be fabricated in which a layer of high-resistance hard magnetic (HM) material is deposited under or over a SV stack to longitudinally bias the free layer through indirect coupling at the edges of the stack. Suitable separation is used to avoid direct magnetic coupling (exchange or Neel) of the HM layer to the ferromagnetic (FM) free layer. During fabrication, the track-width milling step is used to define the width of both the sensor stack and the HM layer. Magnetostatic forces, analogous to the forces exerted by the pinned layer moment transversely on the free layer, act to longitudinally stabilize the free layer antiparallel to the HM moment.

An aspect of this invention is to achieve better stability and sensitivity in a self-stabilized SV sensor by providing an efficient geometry to permit the milling of critical dimensions in a single step. It is an advantage of this invention that the improved geometry provides a consistent stabilization structure and performance from device to device within a wafer and from wafer to wafer. It is another advantage of this invention that aggressive track-width over-milling is permitted because self-aligned insulation can be deposited following the milling step with no changes to the final device track width.

In a preferred embodiment, the invention is a magnetoresistive (MR) SV sensor for sensing an external magnetic field, including a ferromagnetic (FM) pinned layer structure that has a magnetic moment, a FM free layer having two sides and two ends and disposed to couple responsively to the external magnetic field, a nonmagnetic conductive spacer layer disposed on the first side of the FM free layer between the free layer and the pinned layer structure, a nonmagnetic highly-resistive spacer layer adjacent the second side of the free layer, and a hard magnetic (HM) layer having two ends and separated from the free layer by the nonmagnetic highly-resistive spacer layer such that each HM layer end is indirectly magnetically coupled to a corresponding free layer end to stabilize the free layer.

In one aspect, this invention is a magnetic head including a write head having FM first and second pole piece layers that have a yoke portion located between a pole tip portion and a back gap portion, a nonmagnetic write gap layer located between the pole tip portions of the first and second pole piece layers, an insulation stack with at least one coil layer embedded therein located between the yoke portions of the first and second pole piece layers, which are connected at their back gap portions; and a read head having a FM first shield layer, nonmagnetic nonconductive first and second read gap layers located between the first shield layer and the first pole piece layer, and a SV sensor located between the first and second read gap layers with a FM pinned layer structure that has a magnetic momentum an AFM pinning layer exchange coupled to the pinned layer structure for pinning the magnetic moment of the pinned layer structure, a FM free layer having two sides and two ends and disposed to couple responsively to the external magnetic field, a nonmagnetic conductive spacer layer disposed on the first side of the free layer between the free layer and the pinned layer structure, a nonmagnetic highly-resistive spacer layer adjacent the second side of the free layer, and a HM layer having two ends and separated from the free layer by the nonmagnetic highly-resistive spacer layer such that each HM layer end is indirectly magnetically coupled to a corresponding free layer end to stabilize the free layer.

In another aspect, this invention is a magnetic disk drive including at least one magnetic head assembly that has an air bearing surface (ABS) and that includes a write head having FM first and second pole piece layers that have a yoke portion located between a pole tip portion and a back gap portion, a nonmagnetic write gap layer located between the pole tip portions of the first and second pole piece layers, and an insulation stack with at least one coil layer embedded therein located between the yoke portions of the first and second pole piece layers, which are connected at their back gap portions, a read head having a FM first shield layer, nonmagnetic nonconductive first and second read gap layers located between the first shield layer and the first pole piece layer, and a SV sensor located between the first and second read gap layers, with a FM pinned layer structure that has a magnetic moment, a FM free layer having two sides and two ends and disposed to couple responsively to the external magnetic field, a nonmagnetic conductive spacer layer disposed on the first side of the free layer between the free layer and the pinned layer structure, a nonmagnetic highly-resistive spacer layer adjacent the second side of the free layer, and a HM layer having two ends and separated from the free layer by the nonmagnetic highly-resistive spacer layer such that each HM layer end is indirectly magnetically coupled to a corresponding free layer end to stabilize the free layer, a housing, a magnetic disk rotatably supported in the housing, a support mounted in the housing for supporting the magnetic head assembly with said ABS facing the magnetic disk so that the magnetic head assembly is in a transducing relationship with the magnetic disk, a spindle motor for rotating the magnetic disk, an actuator positioning means connected to the support for moving the magnetic head to multiple positions with respect to said magnetic disk, and a processor connected to the magnetic head, to the spindle motor and to the actuator for exchanging signals with the magnetic head, for controlling movement of the magnetic disk and for controlling the position of the magnetic head.

In yet another aspect, this invention is a method of fabricating a MRSV sensor element including the steps of forming a magnetically-permeable (SI) shield layer, forming a gap spacing layer on the (SI) shield layer, forming a HM layer having a magnetic moment on the gap spacing layer, forming a spacing layer on the HM layer, forming a FM free layer on the spacing layer, forming a nonmagnetic conductive SV spacing layer on the FM free layer, forming a FM pinned layer structure having a magnetic moment on the SV spacing layer, removing all material on each side of the SV stack down to the gap spacing layer, whereby the HM layer is magnetostatically coupled to the FM free layer at each side of the SV stack to stabilize the FM free layer.

The foregoing, together with other features and advantages of this invention, can be better appreciated with reference to the following specification, claims and the accompanying drawings which are not to scale.

### BRIEF DESCRIPTION OF THE DRAWINGS

For a more complete understanding of this invention, reference is now made to the following detailed description of the embodiments as illustrated in the accompanying drawing, in which like reference designations represent like features throughout the several views and wherein:

FIG. 1 is a schematic diagram illustrating a spin valve (SV) sensor from the prior art that is stabilized using hard magnetic (HM) layers formed by a lift-off process;

FIG. 2 is a schematic diagram illustrating a SV sensor from the prior art that is stabilized using exchange bias layers, buffered by an intermediate cobalt or tantalum layer;

FIG. 3 is a schematic diagram illustrating an exemplary embodiment of the SV sensor of this invention that is stabilized using a single HM layer under the SV stack and buffered therefrom by an intermediate nonmagnetic layer;

FIG. 4 is a schematic diagram illustrating an alternative embodiment of the SV sensor of this invention that is stabilized using a single HM layer over the SV stack and buffered therefrom by an intermediate nonmagnetic layer;

FIGS. 5A-5E are a series of schematic diagrams illustrating various steps during fabrication of the SV sensor of this invention;

FIG. 6 is a schematic plan view of an exemplary direct access storage device (DASD) suitable for use with the SV sensor of this invention;

FIG. 7 is a view taken along plane 7--7 of FIG. 1 showing a slider with a magnetic read/write head (hidden lines) suitable for use with the SV sensor of this invention;

FIG. 8 is an elevation view of the exemplary DASD from FIG. 6 showing the use of multiple disk and magnetic heads;

FIG. 9 is a partial view of the slider and magnetic head from FIG. 7 as seen in plane 9--9 of FIG. 7;

FIG. 10 is a partial ABS view of the slider and magnetic head from FIG. 7 taken along plane 10--10 of FIG. 9 to show the read and write elements of the magnetic head; and

FIG. 11 is a block diagram of a flow chart showing an exemplary embodiment of the method for fabricating the SV sensor of this invention.

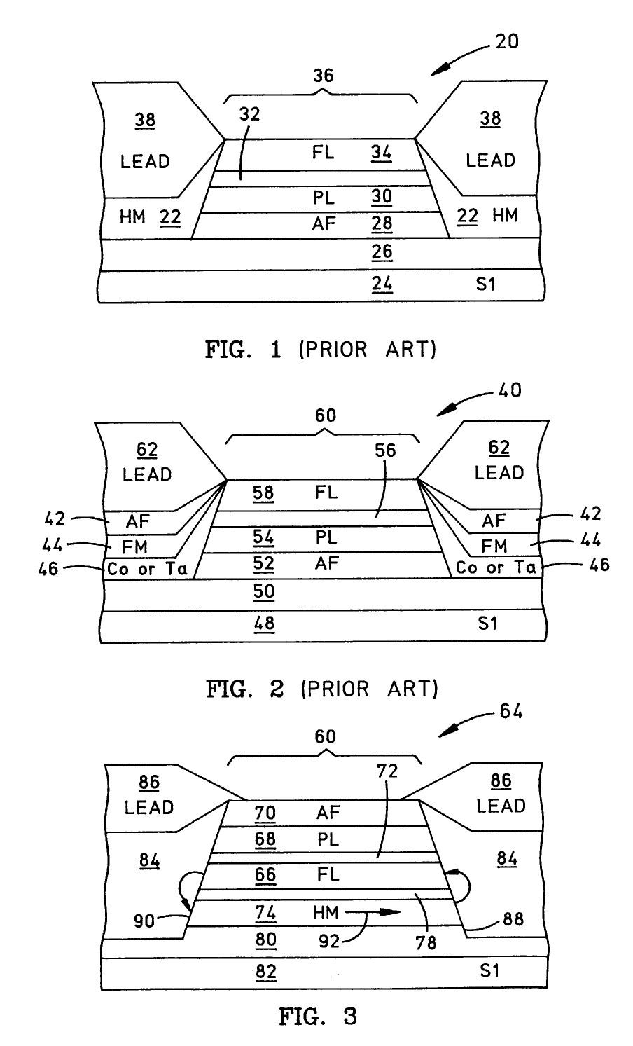

### DESCRIPTION OF THE PREFERRED EMBODIMENT

FIG. 3 shows the spin valve (SV) sensor 64 of this invention embodied with the ferromagnetic (FM) free layer 66 disposed beneath the FM pinned layer 68, which is exchange-coupled to the antiferromagnetic (AFM) pinning layer 70. The conductive spacer layer 72 is disposed between FM free layer 66 and FM pinned layer 68 in the usual manner. FM free layer 66 is stabilized using a single hard magnetic (HM) layer 74 of suitable hard magnetic material over the entire central region 76. HM layer 74 is preferably embodied as a metallic exchange-coupled structure similar to the AFM/FM structure formed by layers 68-70. FM layer 68 in this structure is positioned immediately beneath the spacer layer 78, to minimize the separations between its magnetic moment and that of FM free layer 66. When using an exchange coupled AFM/FM structure, the sensor stack may contain a total of two AFM layers, which must be oriented in two orthogonal directions. This requirement arises because, as described above, the pinned layer must be oriented 90-degrees to the air bearing surface (ABS), while HM layer 74 must be aligned to the ABS to provide a longitudinal stabilizing field.

There are several ways to achieve the orthogonal arrangement of the pinned layer PL and HM. For example, a pinned layer (PL) structure consisting of two FM layers (e.g., CoFe) separated by a thin layer of material (e.g., Ru) may be used to produce a large AFM coupling. Such a PL structure is denominated a “synthetic” or antiparallel (AP) coupled structure. A sensor stack containing a synthetic PL and a HM, each exchange-coupled to its adjacent AFM layer, may be initially set in the transverse direction with a suitable thermal annealing step. Subsequently, the sensor stack may be exposed to a longitudinal external field of a suitable magnitude at a suitable temperature, thereby rotating the magnetic axis of the HM layer towards the longitudinal dimension. Proper selection of fields and temperatures avoids the simultaneous rotation of the synthetic PL moments. An even more advantageous embodiment includes a synthetic PL without an AFM layer in a “self-pinned” configuration, which uses anisotropy rather than exchange-coupling to stabilize the PL magnetization. In the self-pinned design, no AFM is seen in the sensor stack except the AFM used to harden the HM layer and only one longitudinal annealing step is required.

The advantage of an exchange coupled HM structure is that magnetic changes within the layer are minimized. Such changes are common in many high coercivity hard magnets, producing stray field that adversely affect the soft magnetic properties of FM free layer 66. Provided that this adverse effect can be controlled or accepted, HM layer 74 may alternatively be embodied as a high coercivity HM layer with the requisite underlayers needed to control its magnetic properties. To minimize current shunting, such an HM layer should have a high resistance. Alternatively one may minimize shunting by making spacer layer 78 nonconducting to minimize the current entering HM layer 74. In FIG. 3, HM layer 74 is buffered from FM free layer 66 by a thin intermediate layer 78 of insulating nonmagnetic material such as aluminum-oxide or the like. HM layer 74 rests on an insulating layer 80 of aluminum-dioxide or the like, which is deposited on the first shield (S1) layer 82. The thickness of intermediate layer 78 is selected to be as small as possible while avoiding exchange coupling or Neel coupling between HM layer 74 and FM free layer 66.

During the track-width milling step, all material outside of central region 76 is removed down to insulating layer 80 to define the final track width corresponding to central region 76 in FIG. 3. Aggressive track-width over-milling (even down into first shield (S1) layer 82) is permitted because the self-aligned insulation layer 84 is deposited following the milling step to fill in all over-milled regions without affecting the precision of the device track width and without affecting the stabilization bias. After refilling with insulation layer 84, the conductive lead layer 86 is deposited in a manner that leaves a portion of the track edges exposed sufficient to permit current flow from the lead layers to the sensor. The deposition process is therefore adjusted so that the insulation layer has a poor step coverage while the lead layer has a good step coverage. This can be achieved for instance by adjusting the effective angle of deposition. In operation, the magnetic moment (shown as the arrow 92) of HM layer 74 is magnetostatically coupled to FM free layer 66 at the two ends 88 and 90. This coupling biases FM free layer 66 more strongly at edges 88-90 and less so in the middle of central region 76, thereby preserving the sensitivity of SV sensor 64 while also stabilizing it against Barkhausen noise.

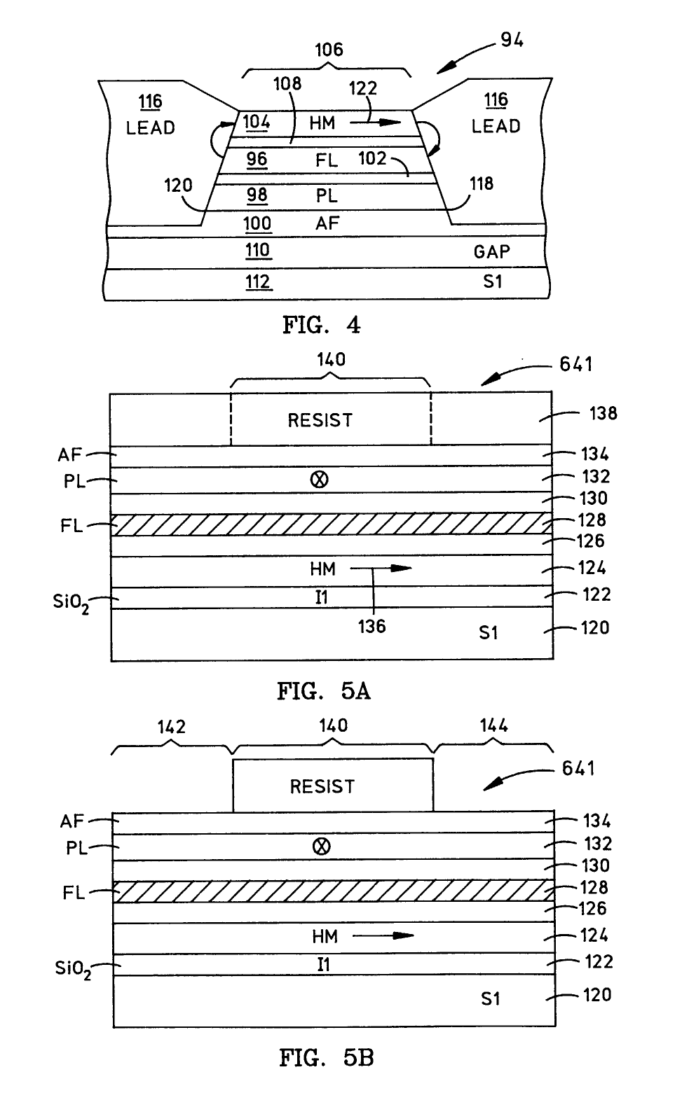

FIG. 4 shows a SV sensor 94 of this invention embodied without an insulation refill layer. The FM free layer 96 disposed above the FM pinned layer 98, which is exchange-coupled to the AFM pinning layer 100. In this embodiment, it is preferable to have FM free layer 96 disposed above FM pinned layer 98 because this allows a complete mill of FM free layer 96 without damage to the underlying insulating layer 110. This approach allows current to be shunted by the single HM layer 104. While this may cause a signal reduction, the disadvantage of any such reduction can be more than offset by the more efficient stabilization. The conductive spacer layer 102 is disposed between FM free layer 96 and FM pinned layer 98 in the usual manner. FM free layer 96 is stabilized using HM layer 104 of suitable hard magnetic material deposited over the entire central region 106 before the track-width milling etch. HM layer 104 is buffered from FM free layer 96 by a thin intermediate layer 108 of highly-resistive nonmagnetic material such as aluminum-oxide or the like. AFM pinning layer 100 rests on insulating layer 110 of aluminum-dioxide or the like, which is deposited on the first shield (S1) layer 112. The thickness of intermediate layer 108 is selected to be as small as possible while avoiding exchange coupling or Neel coupling between HM layer 104 and FM free layer 96. Alternatively, HM layer 104 may be embodied in one of the several fashions discussed above for HM layer 74 in FIG. 3.

During the track-width milling step, all HM and free layer material outside the central region 106 is removed. For better track-width definition, one may mill deeper into the sensor stack, being careful not to damage the insulating quality of insulating layer 110. The conductive lead layer 116 is deposited in the manner described hereinbelow. In operation, the magnetic moment (shown as the arrow 122) of HM layer 104 is magnetostatically coupled to FM free layer 96 at the two ends 118 and 120. This coupling biases FM free layer more strongly at edges 118-120 and less so in the middle of central region 106, thereby preserving the sensitivity of SV sensor 94 while also stabilizing it against Barkhausen noise.

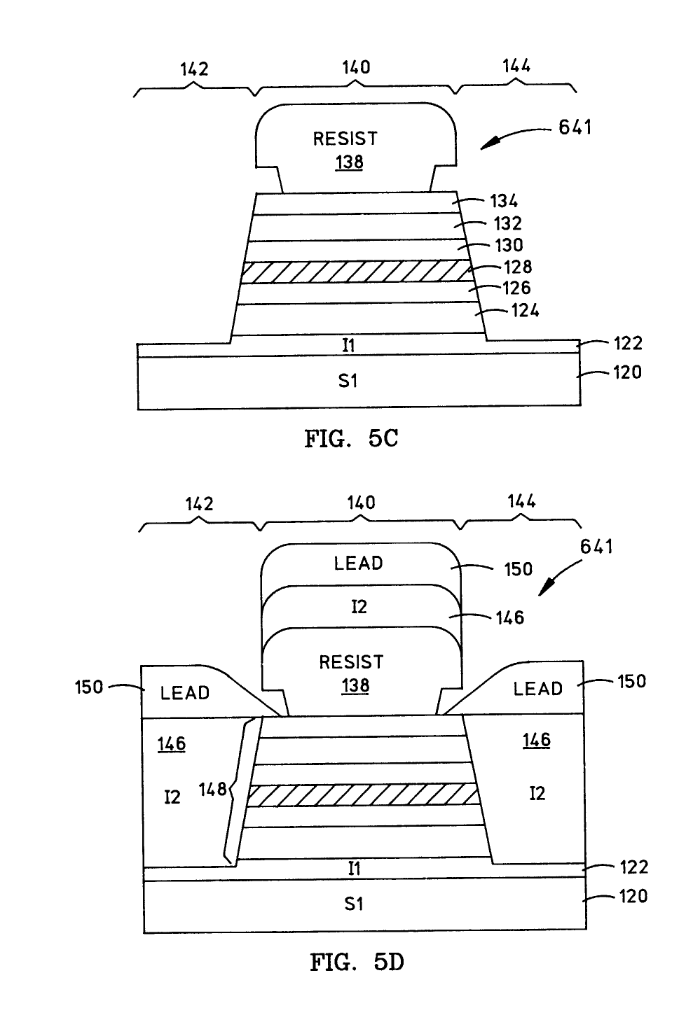

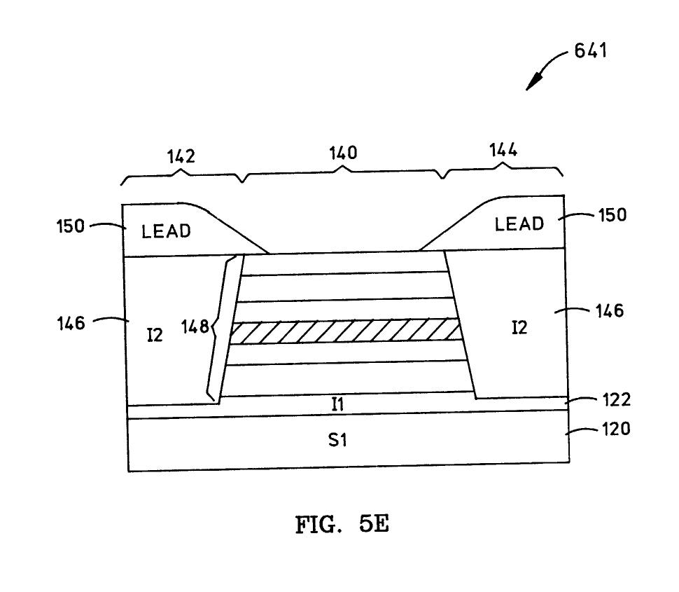

Referring now to FIGS. 5A-5E, the method of making a preferred embodiment of the present invention of an SV sensor 641, like SV sensor 64 discussed above in connection with FIG. 3, is now described. SV sensor 641 can be fabricated in a magnetron sputtering or an ion beam sputtering system to sequentially deposit the multilayer structure shown in FIG. 5A on the first shield (S1) 120. The insulating layer 122, the HM layer 124, the nonmagnetic spacing layer 126, the FM free layer 128, the conductive spacing layer 130, the FM pinned layer 132 and the AFM pinning layer 134 are sequentially deposited over first shield (S1) 120 in the presence of a longitudinal or transverse magnetic field of about 40 Oe to orient the easy axis of all of the FM layers. Insulating layer 122 may be formed of aluminum-dioxide or a similar material. HM layer 124 may be formed of a suitable structure. Alternatively, HM layer 124 may consist of a metallic permanent magnet material or an exchange-biased structure suitable for providing a permanent magnetic moment in the direction shown by arrow 136. Nonmagnetic spacing layer 126 may be formed of a nonmagnetic material such as aluminum-oxide having a thickness in the range of 1-3 nm. FM free layer 128 may be formed of NiFe having a thickness in the range of 2-5 nm. Conductive spacing layer 130 may be formed of copper having a thickness in the range of 1.5-2.5 nm. FM pinned layer 132 may be formed of NiFe having a thickness in the range of 1-3 nm. AFM pinning layer 134 may be formed of Pt₅₀Mn₅₀having a thickness of 0-15 nm. AFM pinning layer 134 is capped with a protective layer such as, for example, Ta having a thickness in the range of 2-5 nm, and is annealed in a magnetic field (applied in the direction shown) at a temperature sufficiently above 240° C. to induce an ordered antiferromagnetic phase in AFM pinning layer 134. A photoresist layer 138 is formed over AFM pinning layer 134. An intermediate layer (not shown) of polydimethylglutarimide (PMGI) may be formed between the photoresist layer 138 and AFM pinning layer 134 to facilitate the lift-off process when removing photoresist 138. The SV stack (central region ) 140 is then defined by any useful photolithographic method known in the art.

FIG. SB shows SV sensor 641 after the photolithography step defining the central (active) region 140. The remaining photoresist masks central region 140 of SV sensor 641 during ion beam milling to define the track width by removing, in the exposed end regions 142-144, the AFM pinning layer 134, FM pinned layer 132, conductive spacing layer 130, free layer 128, nonmagnetic spacing layer 126, HM layer 124 and perhaps some part of insulating layer 122.

FIG. SC shows SV sensor 641 after the track width ion-milling step wherein all material in end regions 142-144 is removed down to insulating layer 122. The insulator and lead structures may now be deposited in end regions 142-144.

FIG. 5D shows SV sensor 641 after deposition of the insulator and lead structures over the entire exposed surface including central region 140 (protected by a remainder of photoresist layer 138) and end regions 142-144. The insulator layer (11) 146 may be formed by ion-beam deposition of aluminum-oxide. Such deposition should be performed at an angle close to a perpendicular to the sensor plane to minimize encroachment of deposited insulator under photoresist layer 138. The lead layer 150 may be formed by ion-beam deposition of rhodium or other suitable conductor to a thickness in the range of 10-20 nm on insulating layer 146. The deposition angle should be sufficiently shallow to induce encroachment of lead material under photoresist layer 138 to provide a path for the sense current. Photoresist layer 138 over central region 140 may now be removed by any useful lift-off process known in the art to expose the multilayer structure of the central (SV stack) region 140.

FIG. 5E shows SV sensor 641 after lift-off of photoresist layer 138 in central region 140. This completes the description of the SV stack deposition process for fabrication of SV sensor 641.

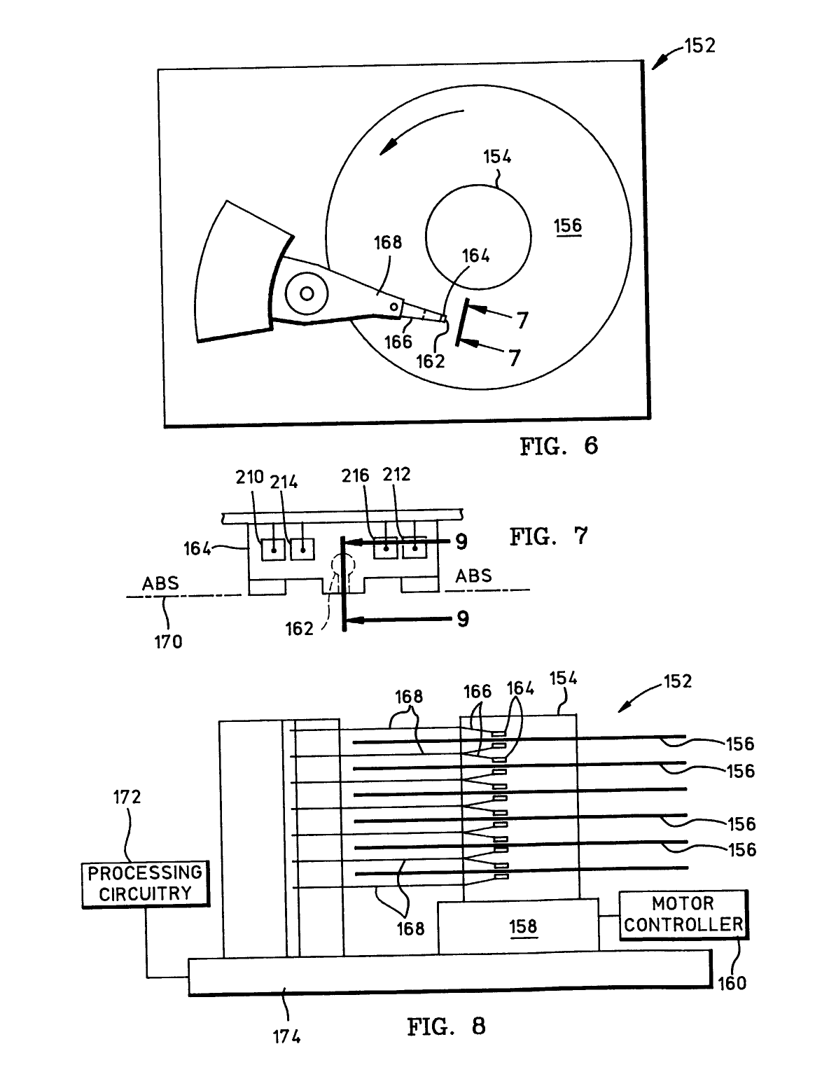

FIG. 6-8 show various aspects of an exemplary direct access storage device (DASD) 152 (also denominated a disk drive) suitable for use with the SV sensor of this invention. DASD 152 includes a spindle 154 that supports and rotates a magnetic disk 156. In FIG. 8, spindle 154 is shown to be rotated by a motor 158 that is controlled by a motor controller 160. A merged SV head 162 incorporating the SV sensor of this invention (FIG. 10) is mounted on a slider 164 that is supported by a suspension 166 and an actuator arm 168. A plurality of disks, sliders and suspensions may be found in a large capacity DASD exemplified by DASD 152 as shown in FIG. 8. Suspension 166 and actuator arm 168 position slider 164 so that merged SV head 162 is in a transducing relationship with a surface of magnetic disk 156. When disk 156 is rotated by motor 158, slider 164 is supported on a thin (typically, 50 nm) cushion of air (denominated an air bearing) between the surface of disk 156 and the air bearing surface (ABS) 170 of slider 164 (FIG. 7). Merged SV head 162 may then be employed for writing information in the form of magnetic field incursions or the absence thereof to multiple circular tracks on the surface of the disk 156, and for reading information in the same form therefrom. The processing circuitry 172 exchanges signals representing such information with merged SV head 162, provides motor drive signals for rotating the magnetic disk 156, and provides control signals for moving slider 164 to various tracks. The components described hereinabove may be mounted on a frame 174, as shown in FIG. 8.

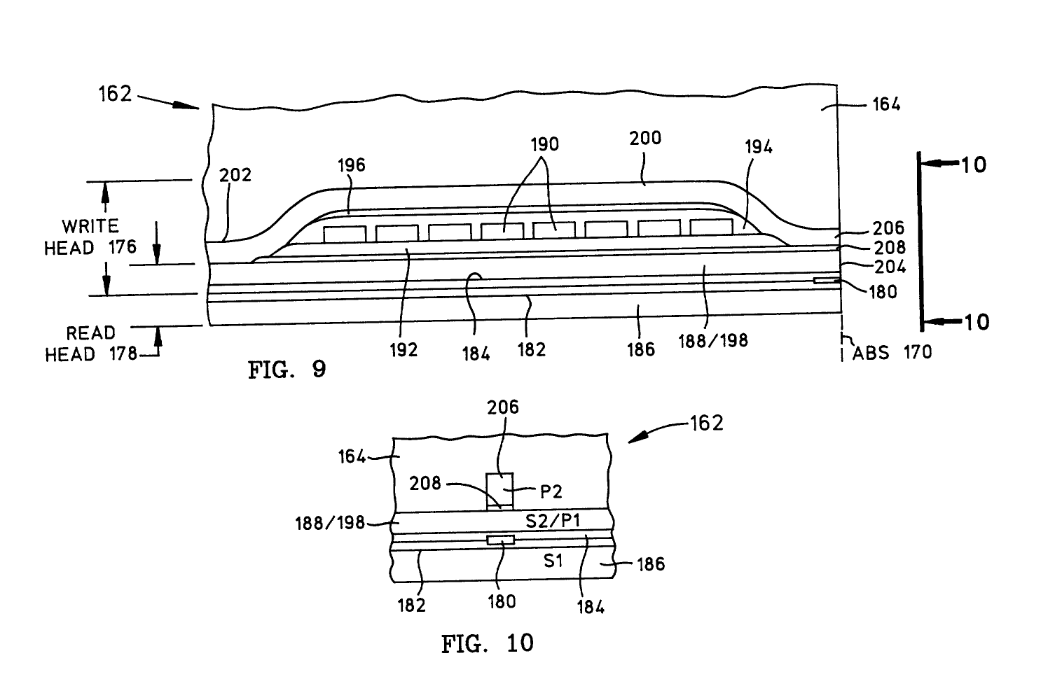

FIG. 9 is a side cross-sectional elevation view of merged SV head 162, which has a write head portion 176 and a read head portion 178. Read head portion 178 includes a SV sensor 180 of this invention described above in connection with FIGS. 3-5E. FIG. 10 is an ABS view of merged SV head 162 from FIG. 9. SV sensor 180 is located between the first and second gap layers 182 and 184, which are both disposed between the first and second shield layers 186 and 188. Responsive to external magnetic fields (not shown), the effective resistance of SV sensor 162 changes as described above. A sense current Is conducted through the sensor causes these resistance changes to be manifested as voltage changes, which are then processed as read-back signals by processing circuitry 172 shown in FIG. 8.

Write head portion 176 of merged SV head 162 includes a coil layer 190 located between the first and second insulation layers 192 and 194. A third insulation layer 196 may be employed for planarizing the head to eliminate ripples in the second insulation layer caused by the coil layer 190. First, second and third insulation layers 192-196 are sometimes denominated an “insulation stack.” Coil layer 190 and insulation layers 192-196 are located between the first and second pole piece layers 198 and 200. First and second pole piece layers 198 and 200 are magnetically coupled at a back gap 202 and have first and second pole tips 204 and 206, which are separated by a write gap layer 208 at ABS 170. As seen in FIG. 7, the first and second solder connections 210 and 212 are provided to connect leads (not shown) from SV sensor 180 to leads (not shown) on the suspension 166 and the third and fourth solder connections 214 and 216 are provided to connect leads (not shown) from coil 190 to other leads (not shown) on the suspension. Merged SV head 162 employs a single layer 188/198 to serve a double function as a second shield layer for the read head and as a first pole piece for the write head. A “piggyback” head employs two separate layers for these functions.

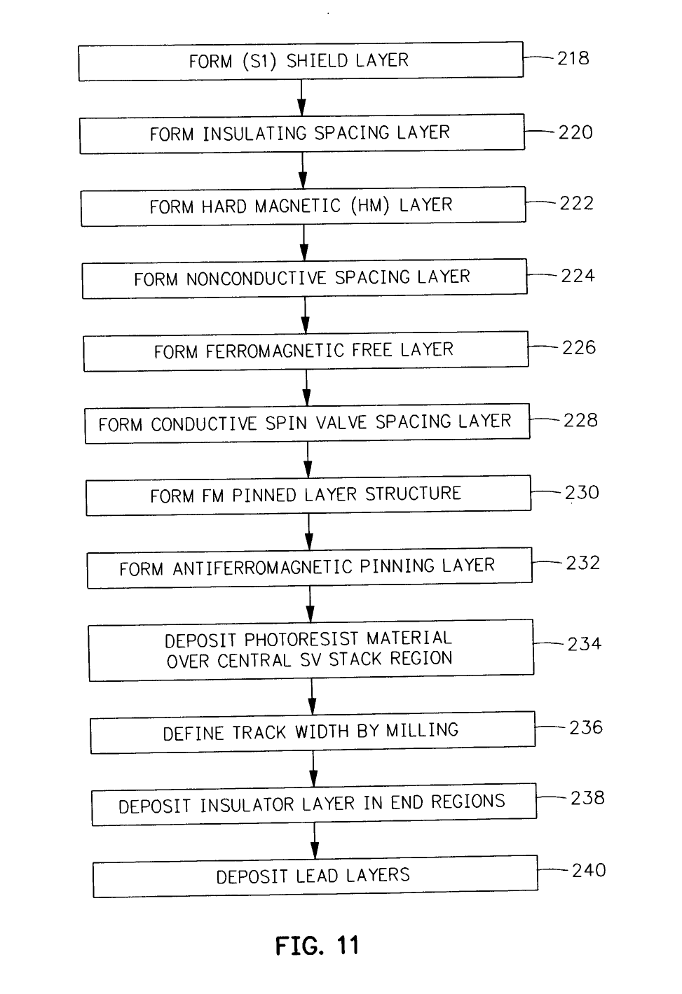

FIG. 11 is a block diagram of a flow chart describing an exemplary embodiment of the method for fabricating the SV sensor of this invention. In the step 218, a first shield (S1) layer of magnetically-permeable material is deposited on a substrate to form the basis for the SV sensor. In the next step 220, a gap spacing layer of insulating material such as silicon-dioxide is deposited on the (SI) shield layer. In step 222, a hard magnetic (HM) layer is deposited on the gap spacing layer in a manner that leaves it with a permanent magnetic moment. Alternatively, step 222 may be performed by depositing metallic material to form a permanent magnetic layer or by depositing an AFM layer exchange-coupled to an FM layer to form an exchange-coupled structure having a magnetic moment. In step 224, a nonconductive stabilizer spacing layer of a suitable material such as aluminum-oxide, just thick enough to avoid exchange-coupling between FM free layer and HM layer, is deposited on the HM layer. In the next step 226, the FM free layer is deposited on the stabilizer spacing layer in the presence of a magnetic field suitable for aligning the magnetic moment of the FM material.

In step 228, a nonmagnetic conductive SV spacing layer of copper or the like is deposited on the FM free layer. In steps 230 and 232, the exchange-biased pinned layer structure is deposited on the SV spacing layer by laying down a layer of FM material followed by another layer of AFM material. In accordance with well-known SV sensor operation, the resulting FM pinned layer has a magnetic moment that resists changes (is “pinned” to one orientation) when exposed to external magnetic fields representing stored data. The photoresist material is deposited in step 234 and selectively removed in a manner that covers the central (active) region (the SV stack) of the SV sensor and leaves exposed the regions on either side of the SV stack.

In step 236, denominated the track-width milling step, suitable equipment, such as ion-milling apparatus, is used to ablate all exposed material down to the level of the insulating spacing layer, or, alternatively, down to the SI shield layer (“over-milling”). This is the step that exposes the edges of the FM free layer and HM layer, permitting magnetostatic coupling between the two at the edges of the SV stack, which provides the desired stabilization precision without degrading sensor sensitivity. Finally, in step 238, the milled end regions are refilled with a suitable insulating material such as silicon-dioxide, and, in step 240, the conductive lead layers are deposited on each side of the SV stack to permit application of the SV sense current in the lateral direction through the SV sensor so that external magnetic fields may be sensed as changes in voltage drop across the SV sensor in the usual manner.

Clearly, other embodiments and modifications of this invention may occur readily to those of ordinary skill in the art in view of these teachings. Therefore, this invention is to be limited only by the following claims, which include all such embodiments and modifications when viewed in conjunction with the above specification and accompanying drawing.

We claim:

1. A spin valve (SV) sensor for sensing an external magnetic field, comprising:
a ferromagnetic (FM) pinned layer structure that has a magnetic moment;
a FM free layer having two sides and two ends and capable of coupling responsively to the external magnetic field;
a nonmagnetic electrically conductive spacer layer disposed on the first side of the FM free layer between the free layer and the pinned layer structure;
a second spacer layer adjacent the second side of the free layer; and
a hard magnetic (HM) layer having two ends and separated from the free layer by the second spacer layer such that each HM layer end is indirectly magnetically coupled to a corresponding free layer end to stabilize the free layer.

2. The SV sensor of claim 1 wherein the second spacer layer is less than 3 nanometers thick.

3. The SV sensor of claim 1 wherein the HM layer ends and the free layer ends are aligned to within 1 nanometer.

4. A magnetic head assembly comprising:
a write head;
a read head including:
a FM first shield layer;
nonmagnetic electrically nonconductive first and second read gap layers located between the first shield layer and the first pole piece layer; and
a spin valve (SV) sensor located between the first and second read gap layers, including:
a FM pinned layer structure that has a magnetic moment;
an antiferromagnetic (AFM) pinning layer exchange coupled to the pinned layer structure for pinning the magnetic moment of the pinned layer structure;
a FM free layer having two sides and two ends and disposed to couple responsively to the external magnetic field;
a nonmagnetic electrically-conductive spacer layer disposed on the first side of the free layer between the free layer and the pinned layer structure;
a second spacer layer adjacent the second side of the free layer; and
a hard magnetic (HM) layer having two ends and separated from the free layer by the second spacer layer such that each HM layer end is indirectly magnetically coupled to a corresponding free layer end to stabilize the free layer.

5. The magnetic head assembly of claim 4 wherein the second spacer layer is less than 3 nanometers thick.

6. The magnetic head assembly of claim 4 wherein the HM layer ends and the free layer ends are aligned to within 1 nanometer.

7. A magnetic disk drive including at least one magnetic head assembly, comprising:
a write head;
a read head including:
a FM first shield layer;
nonmagnetic electrically nonconductive first and second read gap layers located between the first shield layer and the first pole piece layer; and
a spin valve (SV) sensor located between the first and second read gap layers, including:
a FM pinned layer structure that has a magnetic moment;
a FM free layer having two sides and two ends and disposed to respond to the external magnetic field;
a nonmagnetic electrically-conductive spacer layer disposed on the first side of the free layer between the free layer and the pinned layer structure;
a second spacer layer adjacent the second side of the free layer; and
a hard magnetic (HM) layer having two ends and separated from the free layer by the second spacer layer such that each HM layer end is indirectly magnetically coupled to a corresponding free layer end to stabilize the free layer;
a housing;
a magnetic disk rotatably supported in the housing;
a support mounted in the housing for supporting the magnetic head assembly with a head surface facing the magnetic disk so that the magnetic head assembly is in a transducing relationship with the magnetic disk;
a spindle motor for rotating the magnetic disk;
an actuator positioning means connected to the support for moving the magnetic head assembly to multiple positions with respect to said magnetic disk; and
a processor connected to the magnetic head assembly, to the spindle motor and to the actuator for exchanging signals with the magnetic head assembly, for controlling movement of the magnetic disk and for controlling the position of the magnetic head assembly.

8. The disk drive of claim 7 wherein the second spacer layer is less than 3 nanometers thick.

9. The disk drive of claim 7 wherein the HM layer ends and the free layer ends are aligned to within 1 nanometer.

10. A method of fabricating a magnetoresistive (MR) spin valve (SV) sensor element having a central SV stack, the method comprising the steps of:
forming a magnetically-permeable (S1) shield layer;
forming a gap spacing layer on the (S1) shield layer;
forming a hard magnetic (HM) layer having a magnetic moment on the gap spacing layer;
forming a stabilizer spacing layer on the HM layer;
forming a ferromagnetic (FM) free layer on the stabilizer spacing layer;
forming a nonmagnetic electrically conductive SV spacing layer on the FM free layer;
forming a FM pinned layer structure having a magnetic moment on the SV spacing layer;
forming an antiferromagnetic (AFM) pinning layer on the FM pinned layer structure that is exchange coupled to the FM pinned layer structure for pinning the magnetic moment thereof;
removing all material on each side of the SV stack region down to the gap spacing layer, whereby the HM layer is magnetostatically coupled to the FM free layer at each side of the SV stack region to stabilize the FM free layer.

11. The method of claim 10 wherein the HM layer includes an exchange-coupled structure, further comprising the steps of:
forming an AFM stabilizing layer on the gap spacing layer; and
forming a FM stabilizing layer on the AFM stabilizing layer such that the AFM stabilizing layer is exchange-coupled to the FM stabilizing layer for fixing the magnetic moment thereof.

12. The method of claim 10 wherein the removing step further comprises the step of:
removing all material on each side of a SV stack region down to the (S1) shield layer.
